(19) United States
(12) Patent Application Publication
(10) Pub. No.: US 2025/0274876 A1
(43) Pub. Date: Aug. 28, 2025

(54) METHOD BY WHICH IAB PERFORMS COMMUNICATION IN WIRELESS COMMUNICATION SYSTEM, AND APPARATUS THEREFOR

(71) Applicant: LG ELECTRONICS INC., Seoul (KR)

(72) Inventors: Jaenam SHIM, Seoul (KR); Hyunsoo KO, Seoul (KR); Hyangsun YOU, Seoul (KR)

(73) Assignee: LG ELECTRONICS INC., Seoul (KR)

(21) Appl. No.: 18/857,139

(22) PCT Filed: Apr. 21, 2023
(86) PCT No.: PCT/KR2023/005456

§ 371 Date: Oct. 15, 2024

(30) Foreign Application Priority Data
Apr. 21, 2022 (KR) 10-2022-0049734

(51) Int. Cl. H04W 52/36; H04W 76/27

(52) U.S. Cl. CPC H04W 52/36; H04W 76/27

(57) ABSTRACT

Disclosed are a method by which first integrated access and backhaul (IAB) performs communication in a wireless communication system, and an apparatus therefor, according to various embodiments. Disclosed are the method comprising the steps of: receiving radio resource control (RRC) configuration information; forming a backhaul link with a distributed unit (DU) of a second IAB, on the basis of the RRC configuration information; and transmitting a first signal requesting adjustment of transmission power, to the DU of the second IAB through the backhaul link, wherein the first signal comprises a first value selected from a power adjustment range determined on the basis of the RRC configuration information, and the apparatus therefor.

### CROSS-REFERENCE TO RELATED APPLICATIONS

This application is the National Stage filing under 35 U.S.C. 371 of International Application No. PCT/KR2023/005456, filed on Apr. 21, 2023, which claims the benefit of earlier filing date and right of priority to Korean Application No. 10-2022-0049734, filed on Apr. 21, 2022, the contents of which are all hereby incorporated by reference herein in their entireties.

### TECHNICAL FIELD

Embodiments of the present disclosure relate to a method and apparatus for allowing a child JAB (integrated access and backhaul) to perform communication with a parent JAB in a wireless communication system.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR).

### SUMMARY

An object of the present disclosure is to provide a method and apparatus for allowing a child JAB to accurately request power adjustment from a parent JAB within a valid range by predefining and explicitly/implicitly configuring a power adjustment range related to a power change request for a backhaul link, thereby significantly improving the predictability of the power adjustment request.

It will be appreciated by persons skilled in the art that the objects that could be achieved with the various embodiments of the present disclosure are not limited to what has been particularly described hereinabove and the above and other objects that the various embodiments of the present disclosure could achieve will be more clearly understood from the following detailed description.

In accordance with one aspect of the present disclosure, a method for performing communication by a first JAB (Integrated Access and Backhaul) in a wireless communication system may include: receiving radio resource control (RRC) configuration information; forming a backhaul link with a distributed unit (DU) of a second JAB based on the RRC configuration information; and transmitting a first signal requesting adjustment of transmission power to the DU of the second JAB through the backhaul link, wherein the first signal includes a first value selected within a power adjustment range determined based on the RRC configuration information.

The power adjustment range may be determined based on information on a power offset related to a CSI-RS (channel state information reference signal) included in the RRC configuration information.

The RRC configuration information may include information about a first power offset between a secondary synchronization signal (SSS) and a CSI-RS, or information about a second power offset between a PDSCH and a CSI-RS.

The power adjustment range may be determined based on the first power offset or the second power offset.

The first JAB may calculate transmission power of the CSI-RS by applying the first power offset to transmission power related to the SSS, and may determine the power adjustment range based on the calculated transmission power of the CSI-RS.

The first JAB may be configured to: calculate transmission power of the CSI-RS by applying the second power offset to transmission power related to the PDSCH; and determine the power adjustment range based on the calculated transmission power of the CSI-RS.

The power adjustment range may be determined based on instruction information received from the DU included in the second JAB and the RRC configuration information.

The instruction information may include at least one of a minimum value and a maximum value of the power adjustment range.

The first value may be a power offset value for increasing or decreasing transmission power of the DU included in the second IAB.

In accordance with another aspect of the present disclosure, a first IAB (Integrated Access and Backhaul) for performing communication in a wireless communication system may include: a radio frequency (RF) transceiver; and a processor connected to the RF transceiver. The processor may be configured to: receive radio resource control (RRC) configuration information under control of the RF transceiver; form a backhaul link with a distributed unit (DU) of a second JAB based on the RRC configuration information; and transmit a first signal requesting adjustment of transmission power to the DU of the second JAB through the backhaul link, wherein the first signal includes a first value selected within a power adjustment range determined based on the RRC configuration information.

In accordance with another aspect of the present disclosure, a method for performing communication by a second JAB (Integrated Access and Backhaul) in a wireless communication system may include: transmitting radio resource control (RRC) configuration information; forming a backhaul link with a mobile termination (MT) included in the first JAB based on the RRC configuration information; and receiving a first signal requesting adjustment of transmission power for the backhaul link from the MT of the first IAB, wherein the first signal includes a first value selected within a power adjustment range configured by the second IAB, and the power adjustment range is determined based on the RRC configuration information.

The second JAB may be configured to: configure the power adjustment range by instructing the first JAB about at least one of a minimum value and a maximum value of the power adjustment range.

The second IAB may be configured to configure the power adjustment range by instructing the first JAB about transmission power of a CSI-RS (channel state information reference signal).

In accordance with another aspect of the present disclosure, a chipset for performing communication with a second JAB (Integrated Access and Backhaul) in a wireless communication system may include: at least one processor; and at least one memory operatively connected to the at least one processor and configured to, when executed, cause the at least one processor to perform operations, wherein the operations include: receiving radio resource control (RRC) configuration information; forming a backhaul link with a distributed unit (DU) of the second JAB based on the RRC configuration information; and transmitting a first signal requesting adjustment of transmission power to the DU of the second JAB through the backhaul link, wherein the first signal includes a first value selected within a power adjustment range determined based on the RRC configuration information.

In accordance with another aspect of the present disclosure, a computer-readable storage medium is configured to store at least one computer program in a wireless communication system. The computer-readable storage medium may include: at least one computer program for allowing at least one processor to perform communication with a second JAB (Integrated Access and Backhaul); and a computer-readable storage medium configured to store the at least one computer program. The operations may include: receiving radio resource control (RRC) configuration information; forming a backhaul link with a distributed unit (DU) of the second JAB based on the RRC configuration information; and transmitting a first signal requesting adjustment of transmission power to the DU of the second JAB through the backhaul link, wherein the first signal includes a first value selected within a power adjustment range determined based on the RRC configuration information.

Various embodiments may significantly improve the predictability of a power adjustment request while inducing the child JAB to accurately request power adjustment from the parent JAB within a valid range by pre-defining and explicitly/implicitly configuring a power adjustment range related to the power change request for the backhaul link.

Effects to be achieved by embodiment(s) are not limited to what has been particularly described hereinabove and other effects not mentioned herein will be more clearly understood by persons skilled in the art to which embodiment(s) pertain from the following detailed description.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 illustrates the structure of an LTE system to which embodiment(s) are applicable.

FIG. 2 illustrates the structure of an NR system to which embodiment(s) are applicable.

FIG. 3 illustrates the structure of an NR radio frame to which embodiment(s) are applicable.

FIG. 4 illustrates the slot structure of an NR frame to which embodiment(s) are applicable.

FIG. 5 is a schematic diagram of an example for an integrated access and backhaul link.

FIG. 6 schematically illustrates an example of links among DgNB, RN, and UE.

FIG. 7 schematically illustrates an example of a backhaul link and an access link

FIGS. 8 and 9 schematically illustrate examples of parent links and child links in IAB, according to an example.

FIG. 10 is a diagram illustrating an example wherein an IAB node is connected to a parent node 1 and a parent node 2.

FIG. 11 is a flowchart illustrating a method for a first IAB to request adjustment of transmission (Tx) power for a backhaul link formed with a second IAB.

FIG. 12 is a flowchart illustrating a method for a second IAB to configure a power adjustment range for requesting adjustment of transmission (Tx) power for a backhaul link from a first IAB.

FIG. 13 illustrates a communication system applied to the present disclosure.

FIG. 14 illustrates wireless devices applicable to the present disclosure.

FIG. 15 illustrates another example of a wireless device to which the present disclosure is applied.

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto.

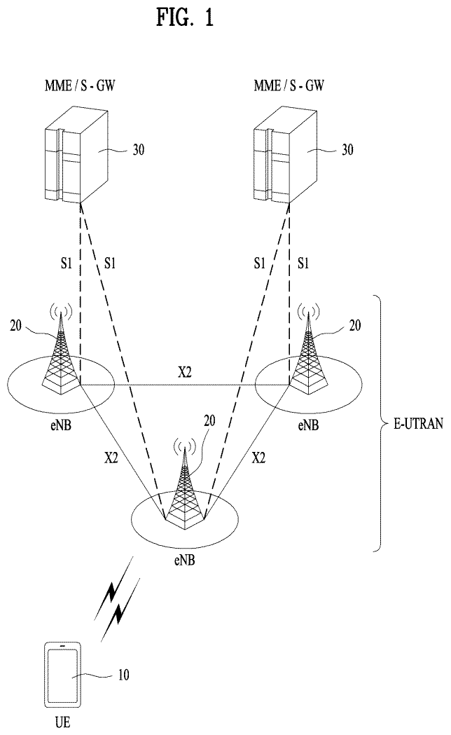

FIG. 1 illustrates the structure of an LTE system to which the present disclosure is applicable. This may also be called an evolved UMTS terrestrial radio access network (E-UTRAN) or LTE/LTE-A system.

Referring to FIG. 1, the E-UTRAN includes evolved Node Bs (eNBs) 20 which provide a control plane and a user plane to UEs 10. A UE 10 may be fixed or mobile, and may also be referred to as a mobile station (MS), user UE (UT), subscriber station (SS), mobile UE (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

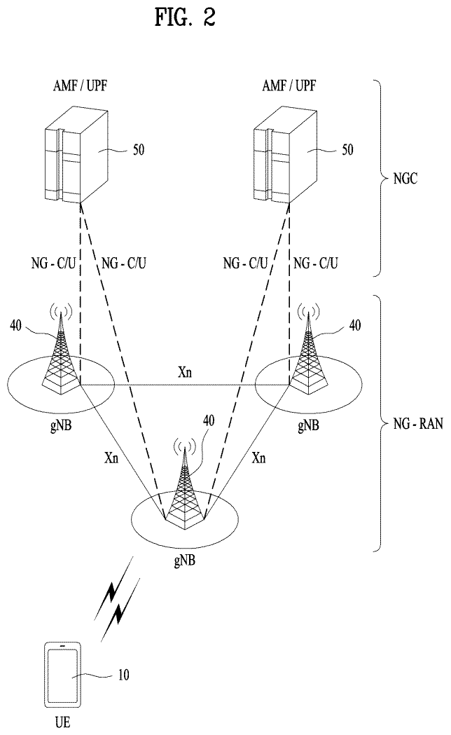

FIG. 2 illustrates the structure of a NR system to which the present disclosure is applicable.

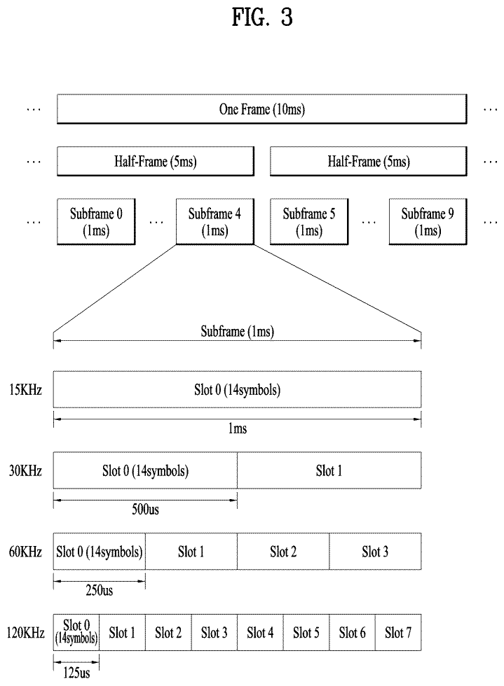

Referring to FIG. 2, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5 GC) via an NG interface. More specifically, the gNB and the eNB are connected to an access and mobility management function (AMF) via an NG-C interface and to a user plane function (UPF) via an NG-U interface.

FIG. 3 illustrates the structure of a NR radio frame to which the present disclosure is applicable.

Referring to FIG. 3, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration p in the NCP case.

TABLE 1

| | | | |
|---|---|---|---|
| SCS (15*2^{u}) | N^{slot}_{symb} | N^{frame, u}ₛₗₒₜ | N^{subframe, u}ₛₗₒₜ |

| | | | | |
|---|---|---|---|---|
| 15 | KHz (u = 0) | 14 | 10 | 1 |
| 30 | KHz (u = 1) | 14 | 20 | 2 |
| 60 | KHz (u = 2) | 14 | 40 | 4 |
| 120 | KHz (u = 3) | 14 | 80 | 8 |
| 240 | KHz (u = 4) | 14 | 160 | 16 |

Table 2 below lists the number of symbols per slot, the number of slots per frame, and the number of slots per subframe according to an SCS in the ECP case.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, different OFDM(A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | | |
|---|---|---|---|
| designation | frequency range | Subcarrier Spacing (SCS) | |
| FR1 | 450 MHz-6000 MHz | 15, 30, 60 | kHz |
| FR2 | 24250 MHz-52600 MHz | 60, 120, 240 | kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | | |
|---|---|---|---|
| designation | frequency range | Subcarrier Spacing (SCS) | |
| FR1 | 410 MHz-7125 MHz | 15, 30, 60 | kHz |
| FR2 | 24250 MHz-52600 MHz | 60, 120, 240 | kHz |

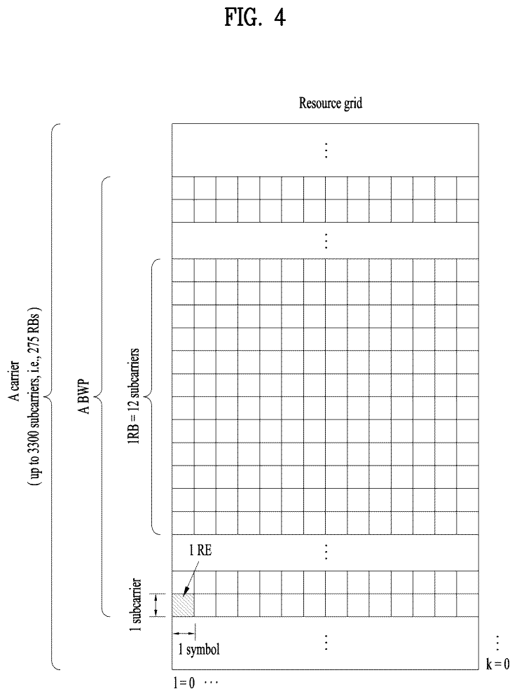

FIG. 4 illustrates the slot structure of a NR i-ame to which the present disclosure is applicable.

Referring to FIG. 4, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

### Bandwidth Part (BWP)

In the NR system, up to 400 MHz may be supported per component carrier (CC). If a UE operating on a wideband CC always operates with the RF for the entire CCs turned on, the battery consumption of the UE may be increased. Alternatively, considering various use cases (e.g., eMBB, URLLC, Mmtc, V2X, etc.) operating within one wideband CC, different numerologies (e.g., sub-carrier spacings) may be supported for different frequency bands within a specific CC. Alternatively, the capability for the maximum bandwidth may differ among the UEs. In consideration of this, the BS may instruct the UE to operate only in a partial bandwidth, not the entire bandwidth of the wideband CC. The partial bandwidth is defined as a bandwidth part (BWP) for simplicity. Here, the BWP may be composed of resource blocks (RBs) contiguous on the frequency axis, and may correspond to one numerology (e.g., sub-carrier spacing, CP length, slot/mini-slot duration).

The BS may configure multiple BWPs in one CC configured for the UE. For example, a BWP occupying a relatively small frequency region may be configured in a PDCCH monitoring slot, and a PDSCH indicated by the PDCCH in a larger BWP may be scheduled. Alternatively, when UEs are concentrated in a specific BWP, some of the UEs may be configured in another BWP for load balancing. Alternatively, a spectrum in the middle of the entire bandwidth may be punctured and two BWPs on both sides may be configured in the same slot in consideration of frequency-domain inter-cell interference cancellation between neighbor cells. That is, the BS may configure at least one DL/UL BWP for the UE associated with the wideband CC and activate at least one DL/UL BWP among the configured DL/UL BWP(s) at a specific time (through L1 signaling, MAC CE or RRC signalling, etc.). The BS may instruct the UE to switch to another configured DL/UL BWP (through L1 signaling, MAC CE or RRC signalling, etc.). Alternatively, when a timer expires, the UE may switch to a predetermined DL/UL BWP. The activated DL/UL BWP is defined as an active DL/UL BWP. The UE may fail to receive DL/UL BWP configuration during an initial access procedure or before an RRC connection is set up. A DL/UL BWP assumed by the UE in this situation is defined as an initial active DL/UL BWP.

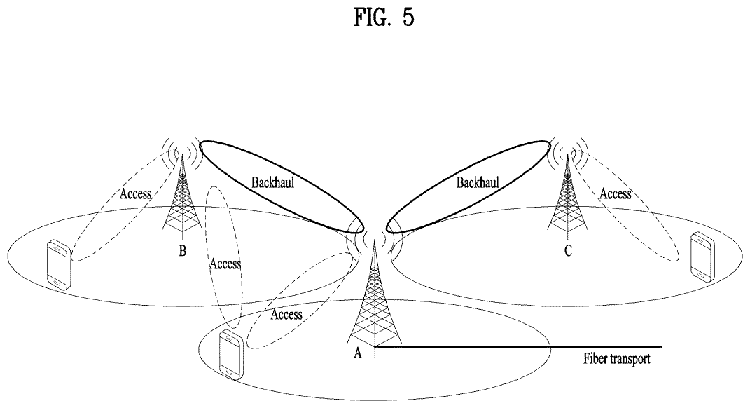

FIG. 5 is a schematic diagram of an example for an integrated access and backhaul link.

An example of a network with such integrated access and backhaul links is shown in FIG. 5, where an JAB node or relay node (rTRP) can multiplex access and backhaul links in time, frequency, or space (e.g., beam-based operations).

The operations of different links may be at the same or different frequencies (also referred to as ‘in-band’ and ‘out-band’ relays). Efficient support of an out-band relay is important in some NR deployment scenarios, but it is very important to understand in-band operational requirements, which mean close interaction with an access link operating at the same frequency, to accept duplex constraints and avoid/mitigate interference.

In addition, operating an NR system in the mmWave spectrum may present several unique challenges, including experiencing severe short-term blocking that may not be easily mitigated by current RRC-based handover mechanisms due to the larger time scale required to complete a procedure in comparison to short-term blocking.

To overcome short-term blocking in mmWave systems, it may require a fast RAN-based mechanism (which does not necessarily require intervention of a core network) for inter-rTRP switching.

The need to mitigate short-term blocking of an NR operation in mmWave spectrum with the need for easier deployment of a self-backhauled NR cell may lead to the need for the development of an integrated framework that enables fast switching of access and backhaul links.

In addition, Over-The-Air (OTA) coordination between rTRPs may be considered as mitigating interference and supporting end-to-end route selection and optimization.

The following requirements and aspects may need to be resolved by an integrated access and wireless backhaul (IAB) for NR.

Efficient and flexible operation for in-band and out-band broadcasting in indoor and outdoor scenarios
Multi-hop and redundant connections
End-to-end route selection and optimization
Backhaul link support with high spectrum efficiency
Legacy NR UE support

Legacy NR (new RAT) is designed to support half-duplex devices. In addition, half duplex of an JAB scenario is supported and worthy of being targeted. Furthermore, a full duplex JAB device may be studied.

In the JAB scenario, if each JAB node or Relay Node (RN) does not have scheduling capability, a Donor gNB (DgNB) must schedule the entire links among DgNB-related RNs and UEs. In other words, the DgNB may collect traffic information from all related RNs, make scheduling decisions for all links, and then inform each RN of schedule information.

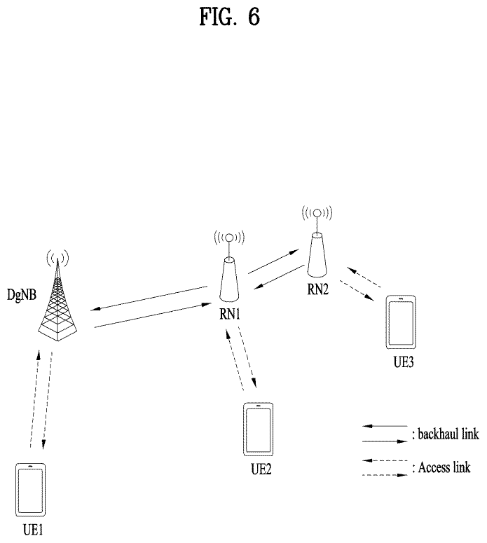

FIG. 6 schematically illustrates an example of links among DgNB, RN, and UE.

According to FIG. 6, a link between DgNB and UE1 may mean an access link, a link between RN1 and UE2 may mean an access link as well, and a link between RN2 and UE3 may mean an access link as well.

Likewise, according to FIG. 6, for example, a link between DgNB and RN1 and a link between RN1 and RN2 may mean backhaul links, respectively.

For example, as in the example of FIG. 6, a backhaul link and an access link may be configured, and in this case, the DgNB may not only receive a scheduling request of the UET but also receive a scheduling request of each of the UE2 and the UE3. Thereafter, the scheduling decision of two backhaul links and three access links may be made and the scheduling result may be notified. Thus, this centralized scheduling includes delay scheduling and latency issues.

On the other hand, distributed scheduling may be performed if each RN has a scheduling ability. This allows immediate scheduling for an uplink scheduling request of a UE, and allows a backhaul/access links to be utilized more flexibly by reflecting surrounding traffic conditions.

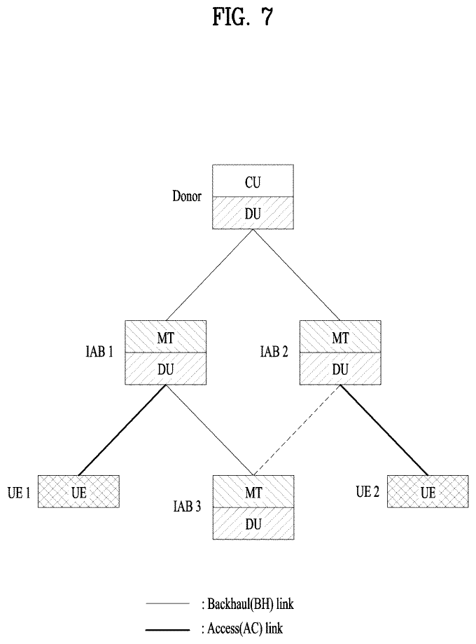

FIG. 7 schematically illustrates an example of a backhaul link and an access link.

As shown in FIG. 7, a link between a donor node and an JAB node or a link between IAB nodes is referred to as a backhaul link. On the other hand, a link between a donor node and an UE or a link between an JAB node and a UE is referred to as an access link. That is, a link between MT and parent DU or a link between DU and child MT may be called a backhaul link, and a link between DU and UE may be called an access link.

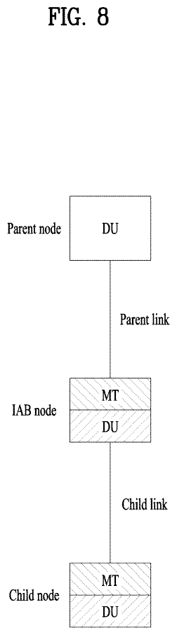

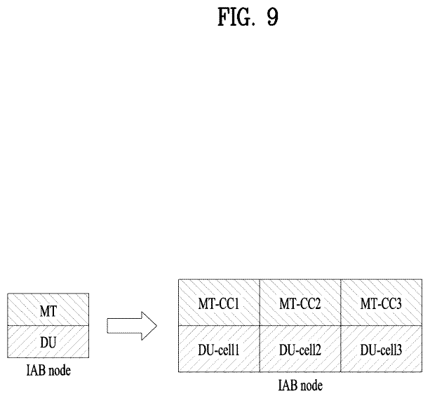

FIGS. 8 and 9 schematically illustrate examples of parent links and child links in IAB, according to an example.

As shown in FIG. 8, a link between an JAB node and a parent node is called a parent link, and a link between an JAB node and a child node/UE is called a child link. That is, a link between MT and parent DU is called a parent link, and a link between DU and child MT/UE is called a child link.

Yet, depending on interpretation or perspective, a link between an JAB node and a parent node may be called a backhaul link, and a link between an JAB node and a child node/UE may be called an access link.

An JAB node may receive a slot format configuration for communication with a parent node and a slot format configuration for communication with a child node/access UE.

In the existing JAB node, a TDM operation in which a DU and an MT operate through different time resources has been performed. On the other hand, resource multiplexing such as SDM/FDM, FC, etc. between the DU and the MT is required for efficient resource operation. As shown in FIG. 7, a link between the IAB node (IAB MT) and the parent node is referred to as a parent link, and a link between the JAB node (IAB DU) and the child node (child MT) is referred to as a child link. At this time, the TDM operation between the parent link and the child link has been discussed, and the SDM/FDM and FD operations are being discussed.

The DU and the MT existing in the same JAB node (or co-located) cannot operate simultaneously due to intra-node interference, slot/symbol boundary misalignment, power sharing, etc., and can operate in TDM. On the other hand, multiplexing of SDM/FDM may be used between the DU and the MT. Such multiplexing is applicable to an example case in which, since DU and MT use different panels, there is little interference between the panels. In this case, DU and MT existing (or co-located) in the same JAB node can transmit or receive data or information simultaneously, but it is impossible for each of the DU and the MT to perform transmission and reception simultaneously or to perform reception and transmission simultaneously.

Alternatively, FD may be used between the DU and the MT. This is applicable in cases where there is little interference between the DU and the MT, such as when a frequency domain where the DU operates and a frequency domain where the MT operates are far apart. In this case, the DU and the MT existing in the same JAB node (or co-located) can freely transmit and receive data simultaneously. The DU and the MT can transmit or receive data simultaneously, and it is also possible for each of the DU and the MT to perform transmission and reception simultaneously or to perform reception and transmission simultaneously.

N MT-CCs and M DU-cells may exist in the IAB node. FIG. 9 shows an example where the IAB node is composed of three MT-CCs (where N=3) and three DU-cells (where M=3). MT-CCs existing in the IAB node may operate through the same or different frequency resources, and one MT-CC may be connected to one or more parent DU-cells. DU-cells existing in the IAB node may operate through the same or different frequency resources.

For a specific MT-CC/DU-cell pair within the IAB node, the MT-CC and the DU-cell may be in either TDM relationship or no-TDM relationship for the following four Tx/Rx direction combinations, and TDM or no-TDM may vary for each Tx/Rx combination.
DU-Tx/MT-Tx
DU-Rx/MT-Rx
DU-Tx/MT-Rx
DU-Rx/MT-Tx

For example, for a specific MT-CC/DU-cell pair, all of the four Tx/Rx combinations can operate with TDM. In this case, the corresponding DU-cell and the corresponding MT-CC should always operate with TDM regardless of Tx/Rx directions of the DU-cell and the MT-CC. In another example, for a specific MT-CC/DU-cell pair, all of the four Tx/Rx combinations can operate with no-TDM. In this case, the corresponding DU-cell and MT-CC can always operate simultaneously with no-TDM regardless of the Tx/Rx directions of the DU-cell and MT-CC. In another example, for a specific MT-CC/DU-cell pair, DU-Tx/MT-Tx and DU-Rx/MT-Rx can operate with no-TDM, and DU-Tx/MT-Rx and DU-Rx/MT-Tx can operate with TDM. The above-described operation relates to a method (e.g., SDM/FDM) for allowing simultaneous operation when the Tx/Rx directions of the DU-cell and the MT-CC are the same, and this method can operate simultaneously when the Tx/Rx directions of the DU-cell and the MT-CC are the same. TDM/no-TDM information for each Tx/Rx combination can be configured/determined differently or independently for each specific MT-CC/DU-cell pair within the IAB node.

At this time, the IAB MT may be connected to two parent DUs using, for example, a dual-connectivity method or a DAPS-HO method.

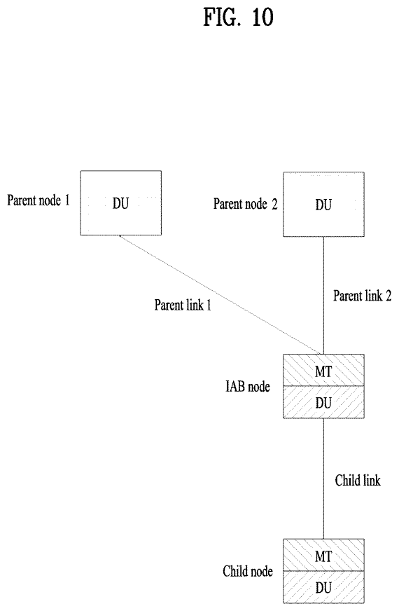

FIG. 10 is a diagram illustrating an example wherein the IAB node is connected to a parent node 1 and a parent node 2.

Referring to FIG. 10, an MT (i.e., IAB MT) within the IAB node may be connected to a DU (i.e., parent DU1) within a parent node 1 and a DU (i.e., parent DU2) within a parent node 2. The link between the parent DU1 and the IAB MT will hereinafter be referred to as a parent link 1, and a link between the parent DU2 and the IAB MT will hereinafter be referred to as a parent link 2. A link between the DU (i.e., IAB DU) within the JAB node, the child JAB node and/or the access UE will hereinafter be referred to as a child link. The parent link 1 and the parent link 2 may be connected through the same or different MT-CCs within the JAB MT. The parent link 1 and the child link can operate using different time resources with TDM. Among the MT-CCs of the JAB node, the MT-CC(s) connected to the parent IAB node 1 will hereinafter be referred to as CG1, the MT-CC(s) connected to the parent JAB node 2 will hereinafter be referred to as CG2, and the MT-CC(s) connected to the parent JAB node x will hereinafter be referred to as CGx. Alternatively, the DU-cells in the parent IAB node 1 connected to the JAB node will hereinafter be referred to as CG1, the DU-cells in the parent JAB node 2 will hereinafter be referred to as CG2, and the DU-cells in the parent JAB node x will hereinafter be referred to as CGx.

One JAB node may have multiple parent JAB nodes, and multiple connected parent IAB nodes may be connected to each other by direct, single-hop, or multi-hop wireless backhaul such that real-time cooperation between parent nodes is impossible. At this time, multiple parent IAB nodes may be connected to the same MT of the JAB node or to different MTs. Each parent JAB node may give AI indications to child nodes thereof.

Hereinafter, an MT may denote an MT-CC, and a DU may denote a DU-cell.

In order to support the resource allocation mechanism for the IAB-node, a semi-static configuration is supported for an IAB-node DU resource configuration. In addition, dynamic indication (L1 signaling) for the JAB node having the availability of soft resources for the IAB-node DU is supported. Based on the existing Rel.15 L1 signaling method, potential improvements (e.g., new slot format), DU/MT behavior rules at the time of multi-hop collision, and processing time constraints at the JAB nodes may be considered.

Meanwhile, DCI format 2_5 may be used to notify of the availability of soft resources. The following information can be transmitted via DCI format 2_5 with CRC scrambled by AI-RNTI.

### Availability Indicator 1, Availability Indicator 2, . . . , Availability Indicator N

The size of DCI format 2_5 with CRC scrambled by AI-RNTI may be configured up to a maximum of 128 bits in the upper layer. Hereinafter, unless otherwise stated, the techniques using the term “UE” are equally applicable to the IAB-node MT of the JAB node.

Meanwhile, the procedure for the IAB-node MT to perform cell search, system information acquisition, and random access is the same as the procedure for the corresponding UE, except for the following procedure. For initial cell selection, the IAB-node MT may assume that half frames having SS/PBCH blocks occur with the periodicity of 16 frames. For PRACH transmission, the IAB-node MT may determine a frame and a subframe within the frame containing a PRACH occasion.

The IAB-node MT may determine an association period for mapping the SS/PBCH block to the PRACH occasion based on the PRACH configuration period according to Table 5. A combined pattern period may include one or more combination periods, and may be determined such that the pattern between the PRACH occasion and the SS/PBCH block is repeated at most every 640 msec. The PRACH occasion of the PRACH slot may be valid depending on conditions.

TABLE 5

| PRACH configuration period | Association period (number of |
|---|---|
| (msec) | PRACH configuration periods) |
| 10 | {1, 2, 4, 8, 16, 32, 64} |
| 20 | {1, 2, 4, 8, 16, 32} |
| 40 | {1, 2, 4, 8, 16} |
| 80 | {1, 2, 4, 8} |
| 160 | {1, 2, 4} |
| 320 | {1, 2} |
| 640 | {1} |

### Method for Indicating Downlink Transmission (Tx) Power of gNB (IAB-DU)

Downlink power of the IAB-DU (gNB) may be indicated via RRC with “ServingCellConfigCommon information element” of Table 6 below and/or “NZP-CSI-RS-Resource information element” of Table 7 (see 3GPP TS 38.331, TS 38.213) [122][Table 6]

TABLE 6 [symbol]
ASN1START [symbol]
TAG-SERVINGCELLCONFIGCOMMON-START

| | |
|---|---|
| ServingCellConfigCommon ::= | SEQUENCE [symbol] |
| physCellId | PhysCellId |

OPTIONAL, [symbol] Cond HOAndServCellAdd,

| | |
|---|---|
| downlinkConfigCommon | DownlinkConfigCommon |

OPTIONAL, [symbol] Cond HOAndServCellAdd

| | |
|---|---|
| uplinkConfigCommon | UplinkConfigCommon |

OPTIONAL, [symbol] Need M

| | |
|---|---|
| supplementaryUplinkConfig | UplinkConfigCommon |

OPTIONAL, [symbol] Need S

| | |
|---|---|
| n-TimingAdvanceOffset | ENUMERATED { n0, n25600. n39936 } |

OPTIONAL, [symbol] Need S

| | |
|---|---|
| [symbol] sb-PositionsInBurst | CHOICE [symbol] |
| shortBitmap | BIT STRING (SIZE (4)) [symbol] |
| mediumBitmap | BIT STRING (SIZE (8)) [symbol] |
| longBitmap | BIT STRING (SIZE (64)) |

[symbol]

OPTIONAL, [symbol] Cond AbsFreqSSB

| | |
|---|---|
| ssb-periodicityServingCell | ENUMERATED { ms5, ms10, ms20, ms40, ms80, ms160, spare2, spare1 } [symbol] OPTIONAL, [symbol] |

Need S

| | |
|---|---|
| dmrs-TypeA-Position | ENUMERATED {pos2, pos3} [symbol] |
| [symbol] te-CRS-ToMatchAround | SetupRelease { RateMatchPatternLTE-CRS } |

OPTIONAL, [symbol] Need M

| | |
|---|---|
| rateMatchPatternToAddM [symbol] dList | SEQUENCE (SIZE (1..maxNrofRateMatchPatterns)) OF RateMatchPattern OPTIONAL, |

[symbol]

Need N

| | |
|---|---|
| rateMatchPatternToReleaseList | SEQUENCE (SIZE (1..maxNrofRateMatchPatterns)) OF RateMatchPatternId OPTIONAL, [symbol] |

Need N

| | |
|---|---|
| ssbSubcarrierSpacing | SubcarrierSpacing |
| OPTIONAL, [symbol] Cond HOAndServCellWithSSB | |
| tdd-UL-DL-ConfigurationCommon | TDD-UL-DL-ConfigCommon |
| OPTIONAL, [symbol] Cond TDD | |
| ss-PBCH-BlockPower | INTEGER ( [symbol] 60 [symbol] 50) [symbol] |
| [symbol] | |
| [symbol] | |
| [symbol] | |
| [symbol] | |

[symbol]

indicates data missing or illegible when filed

Here, ss-PBCH-BlockPower may be the average EPRE of resource elements (REs) carrying a secondary synchronization signal in dBm used by NW for SSB transmission (see 3GPP TS 38.213).

TABLE 7
-- ASN1START
-- TAG-NZP-CSI-RS-RESOURCE-START

| NZP-CSI-RS-Resource ::= | SEQUENCE { | |
|---|---|---|
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED {db [symbol] 3, db0, db3 [symbol] db6} | OPTIONAL, [symbol] Need R |
| scramblingID | ScramblingId, | |
| periodicityAndOffset | CSI-ResourcePeriodicityAndOffset | OPTIONAL, -- Cond PeriodicOrSemiPersis |
| qc [symbol] -InfoPeriodicCSI-RS | TCI-StateId | OPTIONAL, -- Cond Periodic |

...
}
-- TAG-NZP-CSI-RS-RESOURCE-STOP
-- ASN1STOP [symbol]
indicates data missing or illegible when filed

Here, powerControlOffset is a power offset (dB value) of PDSCH RE for NZP CSI-RS RE (see TS 38.214, sections 5.2.2.3.1 and 4.1), powerControlOffsetSS is a power offset (dB value) of NZP CSI-RS RE for SS RE (see TS 38.214, sections 5.2.2.3.1).

That is, the JAB-MT may receive a dBm-based instruction message indicating a transmission signal strength of a secondary synchronization signal transmitted by a parent IAB-DU in ss-PBCH-BlockPower, and may receive a dBm-based instruction message indicating the transmission power of a specific NZP-CSI-RS-Resource using an offset value related to an SSS RE, so that the IAB-MT may infer the transmission power of the NZP-CSI-RS-Resource transmitted by the parent IAB-DU.

### Desired Downlink Power Adjustment Request of IAB-MT

In order to guarantee performance of the backhaul link, power control of the IAB-DU is absolutely necessary, so that the desired power adjustment may be defined as auxiliary information of DL power control.

Meanwhile, in relation to the desired power adjustment, the following scenario may be considered.

The information to assist DL power allocation of the parent-node is indicated by the IAB-MT to the parent node DU in terms of desired power adjustment.

FFS Applicability of Assistance Information, e.g. Per Multiplexing Scenario, Per Resource, Etc.

When the parent IAB receives the desired power adjustment from the child IAB-MT, the parent IAB needs to instruct the child IAB-MT as to whether to accept the power adjustment according to the desired power adjustment. When there is no such instruction, the UE (or the child IAB-MT) cannot know that the transmission power of the gNB has been lowered or increased, which may affect estimation of a path loss of the UE, etc. In other words, the amount of change in the transmission power compared to a signal (or reference) that the UE expects to transmit at constant power, such as SSB or CSI-RS, must be instructed or updated to the UE, and such instruction or update can be performed via RRC. However, DL power control according to the simultaneous operation of the IAB can be performed dynamically. Therefore, the gNB needs to dynamically inform the UE of a change in DL transmission power through MAC-CE or DCI.

The cases in which the desired power adjustment for a DL PC according to the multiplexing scenario or the simultaneous operation is considered are as follows.

Multiplexing Case B (MT Rx DU Rx): (Depending on the implementation) Desired power adjustment may be requested to limit a reception (Rx) power level within a certain range for the purpose of ensuring the stability of AGC operation, preventing quantization distortion, ensuring the linearity of amplifier, etc. For example, the desired power adjustment may be requested so that the received power of the MT and the received power of the DU can be matched.

Multiplexing Case D (MT Rx DU Tx): In the case of SSB, CSI-RS, etc., which are signals having power levels that are expected not to change among the DL signals of the child link, an SI having a large power level may be generated in the MT Rx due to a difference in the size of the transmission power of the DU Tx. In other words, the transmission (Tx) power of the DU Tx may be greater than the reception (Rx) power of the SSB and the reception (Rx) power of the CSI-RS (for the MT Rx), and a considerable signal interference may occur in the MT Rx due to the transmission power of the DU Tx. Therefore, the IAB-MT may request the parent IAB-DU to adjust the desired power so that the power level of the reception signal in the MT can be boosted.

Unlike the UL PC, the multiplexing case B may request an increase or decrease in the transmission power of the parent IAB-DU through a signal for the desired power adjustment. The multiplexing case D may request an increase in the transmission power of the parent IAB-DU through a signal for the desired power adjustment. Therefore, it may be considered that auxiliary information is utilized in relation to the desired power adjustment in the multiplexing scenario. Such desired power adjustment for DL power control or the application range for DL power control may not be defined or applied to cell-specific signals, but may be defined or applied only to UE-specific signals. This is because the power change of cell-specific signals due to desired power adjustment affects the entire cell coverage.

Hereinafter, although the following description explains power control of the IAB-DU based on the request of the IAB-MT, the IAB-MT may be replaced with the UE and the IAB-DU may be replaced with the gNB. In addition, although the following technology shows a single panel/single RF IAB, this technology can also be applied to multi-panel, multi-RF, and multi-RF IAB.

That is, the IAB-MT described below may be extended and applied to the UE, and the IAB-DU may be extended and applied to the gNB and the base station (BS). The IAB-MT may request desired downlink power control with MAC-CE, and the IAB-DU may update the downlink power control provided with the MAC-CE. The reference for such downlink power control may be the current CSI-RS transmission (Tx) power. That is, the request and update of the downlink power control may be an offset of the current CSI-RS transmission (Tx) power reference. In addition, a bit width of the MAC-CE including (or corresponding to) an instruction related to the request and update of the downlink power control may be fixed or variable. Hereinafter, when the IAB-MT requests downlink power control (i.e., when the request of desired downlink power control is performed within a specific range), a method for indicating and/or determining the range in which the IAB-MT can request downlink power control will hereinafter be described in detail. In addition, a desired downlink power control request of the IAB-MT based on the above-mentioned instruction method and/or determination method and the operation of the parent IAB-DU according to the above request will be described in detail. In addition, the operation for downlink power control of the parent IAB-DU and the range of such power control operation (i.e., the operation and range related to the provided downlink power control) will be described in detail.

### Configuring the Power Offset Range for the Desired Downlink Power Request

The IAB-MT may perform reporting (or, instructing and/or requesting) related to the desired downlink power adjustment through MAC-CE, but the content of such report and the method of such reporting need to be clearly defined.

Specifically, the following three scenarios can be considered with respect to the content of such report and this reporting method. First, the power offset range for which the desired downlink power adjustment of the IAB-MT can be requested may be explicitly configured by the parent IAB-DU (Scenario 1). Second, the power offset range for which the desired downlink power adjustment of the IAB-MT can be requested may be implicitly configured by the parent IAB-DU (i.e., not explicitly configured) (Scenario 2). Third, the power offset range for which the desired downlink power adjustment of the IAB-MT can be requested may be neither explicitly nor implicitly configured by the parent IAB-DU (Scenario 3). Meanwhile, the Scenarios 1, 2, and 3 proposed below can be applied in combination with each other.

(1) Scenario 1: When the power offset range for which the desired downlink power adjustment of the IAB-MT can be requested is explicitly configured or instructed by the parent IAB-DU, this case is referred to as Scenario 1.

The IAB-MT may expect that the parent IAB-DU explicitly configures or instructs the power offset range for the request for the desired downlink power adjustment. That is, the IAB-MT may consider or understand that, according to the following method, the operation of the parent IAB-DU that configures or instructs the power offset range for the desired downlink power adjustment (or a desired DLPC) is an instruction indicating that the IAB-MT recognizes the fact that the desired downlink power adjustment (or a desired DLPC) can be requested. Alternatively, when the power offset range for the request for the desired downlink power adjustment is not explicitly configured or indicated, the IAB-MT may request the desired downlink power adjustment (or a desired DLPC) based on a specific power offset range determined by predetermined agreement/promise, etc. before occurrence of the indication or configuration.

Meanwhile, in the following description, even if the request for desired downlink power adjustment (or the request for desired DLPC) is used in parallel, it will be understood as a corresponding configuration that requests power adjustment from the parent IAB-DU. In addition, for convenience of description, the power offset range for the request for desired downlink power adjustment or the request for (desired) DLPC will hereinafter be defined as a DLPC power offset range, and then explained.

The power offset range considering the dynamic range of the DL Tx power of the parent IAB-DU may be configured or instructed to the IAB-MT as the DLPC power offset range (a dynamic range of the DL Tx power of the IAB-DU is defined in 6.3.1.3 of TS38.174, and values of the dynamic range are shown in Table 6.3.3.2-1 of TS 38.104). That is, from the parent IAB-DU's perspective, the power offset range for the DLPC can be indicated based on the transmission (Tx) power and dynamic range of the CSI-RS power configured in the (child) IAB-MT. That is, the DLPC power offset range may be indicated together with the configuration of the CSI-RS, or may be updated based on a change in the CSI-RS transmission (Tx) power. Alternatively, since it is difficult for the IAB-MT to recognize the actual transmission power of the CSI-RS power of the parent IAB-DU, from the IAB-MT's perspective, the DLPC power offset range can be configured regardless of the configuration of the CSI-RS and/or a change in the transmission (Tx) power of the CSI-RS.

The indication of the DLPC power offset range of the IAB-MT may consider at least one of the following options:

Option 1: The parent IAB-DU may indicate a single DLPC power offset range to the IAB-MT.

For example, when the parent IAB-DU indicates the DLPC power offset range of the IAB-MT from −A (dB) to 0 (dB), the parent IAB-DU may consider that the value ‘A’ is indicated to the IAB-MT with RRC/MAC-CE/DCI. Alternatively, when the parent IAB-DU indicates the DLPC power offset range of the IAB-MT from 0 (dB) to A (dB), the parent IAB-DU may indicate the value A to the IAB-MT via RRC/MAC-CE/DCI. Similarly, when the parent IAB-DU indicates the A value to the IAB-MT with RRC/MAC-CE/DCI, the parent IAB-DU may indicate whether the DLPC power offset range of the IAB-MT indicated by the parent IAB-DU is from 0 (dB) to A (dB) or from −A (dB) to 0 (dB) by adding a 1-bit indicator or flag. Alternatively, in order to reduce signaling overhead, when the DLPC power offset range of the IAB-MT indicated by the parent IAB-DU is from −A (dB) to A (dB), the parent IAB-DU may consider that the A value is indicated to the IAB-MT via RRC/MAC-CE/DCI.

In another example, when the DLPC power offset range of the IAB-MT indicated by the parent IAB-DU is from −A (dB) to B (dB), the parent IAB-DU may indicate the values of A and B to the IAB-MT via RRC/MAC-CE/DCI. That is, the parent IAB-DU may indicate the range for Tx power boosting and/or Tx power reduction according to the desired downlink power adjustment request to the IAB-MT, respectively.

The parent IAB-DU may indicate the DLPC power offset range reported by the IAB-MT. In this case, the parent IAB-DU may indicate the smallest and largest values related to the DLPC power offset range, respectively. In particular, one of the two values may be fixed, and the parent IAB-DU may indicate one value related to the DLPC power offset range. For example, the largest value of the DLPC power offset range may be fixed to one specific value, and the parent IAB-DU may designate and indicate one of the plurality of candidate values as the smallest value of the DLPC power offset range. Alternatively, the smallest value of the DLPC power offset range may be fixed to one specific value, and the parent IAB-DU may designate and indicate one of the plurality of candidate values as the largest value of the DLPC power offset range. Here, the plurality of candidate values may be indicated through a higher layer signal. Alternatively, the plurality of candidate values may be indicated or determined in advance through a higher layer signal. After the plurality of candidate values is determined or indicated, one of the plurality of candidate values may be indicated through a higher layer signal. For example, one of the plurality of candidate values may be indicated as the fixed specific value through a higher layer signal. Here, the higher layer signal may include a signal such as an RRC signal or a MAC-CE.

(2) Option 2: The parent IAB-DU may instruct the IAB-MT about multiple DLPC power offset ranges.

For example, the parent IAB-DU may instruct the IAB-MT about a set of DLPC power offset ranges (DLPC range set or DLPC range set) of the IAB-MT in advance, and may instruct the IAB-MT about which DLPC power offset range among the DLPC power offset ranges included in the instructed set is to be used for such instruction. Such instruction operation may be performed via RRC/MAC-CE/DCI.

In another example, the IAB-MT may enable the set of DLPC power offset ranges to be preset or predefined (agreed upon or promised in advance), and the parent IAB-DU may instruct the IAB-MT about which DLPC power offset range in the set is to be used for the operation of requesting the desired power adjustment. Such instruction may be performed via RRC/MAC-CE/DCI.

The above-described set may be a set composed of the DLPC power offset ranges having different minimum and/or maximum values of the power offset range. For example, when the DLPC power offset range is composed of [−A (or minimum value), . . . , B (or maximum value)], the set may be composed of the DLPC power offset ranges in which the B values are the same and only the A values are different from each other. Alternatively, the set may be composed of the DLPC power offset ranges in which the A values are the same and only the B values are different from each other. Alternatively, the set may be composed of the DLPC power offset ranges in which both the B value and the A value are different from each other. That is, the set may be composed of the DLPC power offset ranges in which the minimum values and the maximum values are different from each other, or may be composed of the DLPC power offset ranges in a subset relationship. For example, the DLPC power offset ranges having different minimum and maximum values are represented by different positive numbers A, B, C, D, E, F as [−A, . . . , B], [−C, . . . , D], [−E, . . . , F]. Meanwhile, the subset relationship may mean that some parts are the same, such as [−A, . . . , B], [−C, . . . , B], [−E, . . . , F], [−E, . . . , B]. In other words, the set may be composed of the DLPC power offset ranges that have different maximum and/or minimum values.

Meanwhile, the number of DLPC power offset ranges constituting the set may be the same as the number of the granularity and offset ranges constituting the set. In addition, the DLPC power offset ranges constituting the set may be configured in the same number. For example, when one DLPC power offset range in the set composed of the DLPC power offset ranges is composed of [B+A, B+(A−1)/N, B+(A−2)/N, . . . , B+(A−k)/N, . . . , B+(A−N−1)/N] and the number of elements of the DLPC power offset range is N, all of the DLPC power offset ranges included in the set may be composed of N elements. In other words, each of the DLPC power offset ranges included in the set may include the same number of power values with the same interval or the same number of offset values with the same interval.

In another example, a column of values having different ranges may be defined, a plurality of candidate “columns” may be defined, and one of the plurality of columns may be selected. The column of another value may be a predetermined value, or may be created or defined by a higher layer signal. When the candidate column of another value corresponds to a predetermined value, one of the columns may be indicated by a higher layer signal or a higher layer. Here, the higher layer signal may include a signal such as an RRC signal or a MAC-CE.

According to the above-described methods or options, it may be assumed or understood that the parent IAB-DU indicates that the DLPC power offset range (or the offset range of the desired downlink power control) configured or indicated in the IAB-MT is the same as the offset range of the provided downlink power control, or the IAB-MT may assume or appreciate that the DLPC power offset range is equal to the offset range of the provided downlink power control without using the above instruction.

(2) Scenario 2: When the parent IAB-DU implicitly configures or instructs the IAB-MT, this case is referred to as Scenario 2.

The IAB-MT may expect that the parent IAB-DU implicitly (or explicitly) instructs or configures the DLPC power offset range that is a power offset range in which the desired downlink power adjustment can be requested. It may be understood that the parent IAB-DU that (implicitly) configures the DLPC power offset range by the following method to be described below is an instruction for the IAB-MT to request the desired downlink power adjustment.

Option 1: IAB-MT may derive the CSI-RS transmission (Tx) power of the parent IAB-DU, and the parent IAB-DU may implicitly indicate the DLPC power offset range based on the CSI-RS transmission (Tx) power derived from the IAB-MT.

For example, the IAB-MT may calculate the CSI-RS transmission power of the current parent IAB-DU using powercontroloffset, powercontroloffsetSS, etc. of the IE of the configured CSI-RS and the transmission power of the PDSCH and/or SSB indicated to the IAB-MT (or measured by the IAB-MT). The IAB-MT may estimate or calculate the DLPC power offset range according to a predetermined rule based on the calculated CSI-RS transmission power of the current parent IAB-DU. For example, the IAB-MT may estimate or calculate the DLPC power offset range based on a transmission power ratio of the CSI-RS RE to the indicated PDSCH RE (or an offset between the transmission power of the indicated PDSCH RE and the transmission power of the CSI-RS RE). Alternatively, the IAB-MT may estimate or calculate the DLPC power offset range based on the transmission power ratio of the CSI-RS RE to the indicated SS/PBCH block RE (or a difference between the transmission power of the indicated SS/PBCH block RE and the transmission power of the CSI-RS RE) and the transmission power per SS/PBCH block RE (or the measured transmission power per SS/PBCH block RE). For example, when the SSB transmission power is 23 dBm and the IAB-MT derives the transmission power of the CSI-RS as 22 dBm using the transmission power ratio of the CSI-RS to the SSB transmission power (or the offset value of the transmission power of the CSI-RS based on the transmission power of the SSB), the IAB-MT may consider or determine that the DLPC power offset range is implicitly instructed to be +X (dB), −Y (dB) (or [−Y, . . . , +X]). In this case, X and Y values may be configured in consideration of the range of the transmission power of the CSI-RS. That is, X and Y values may be limited by the maximum transmission power and/or minimum transmission power of the CSI-RS. For example, when the maximum transmission power of the CSI-RS is 25 dBm, the IAB-MT may consider or determine that the X value is 3.

Alternatively, according to the above-described methods or options, the parent IAB-DU may instruct the IAB-MT that the DLPC power offset range (or the offset range of the desired downlink power control) configured or instructed is the same as the offset range of the provided downlink power control, or even without such instruction, the IAB-MT may assume or understand that the DLPC power offset range and the offset range of the provided downlink power control are the same.

(3) Scenario 3: When the parent IAB-DU does not configure the DLPC power offset range of the IAB-MT, this case is referred to as Scenario 3.

In this case, a table related to the DLPC power offset range may be defined separately or in advance. In this case, the IAB-MT and the IAB-DU may have a common understanding of the DLPC power offset range based on the table.

Alternatively, the IAB-MT may expect the parent IAB-DU to configure or instruct the DLPC power offset range, but the IAB-DU may not configure the DLPC power offset range. Even in this case, a request for the desired power control may be possible based on the table defined or agreed upon in advance as described above. That is, the IAB-MT may determine that, even if the parent IAB-DU may be instructed about the DLPC power offset range, a request for the desired power control based on a table that is defined by default or based on a predefined table may be performed if there is no instruction about such instruction.

Alternatively, when the DLPC power offset range is determined or defined in advance, at least one of a plurality of values included in the DLPC power offset range defined in advance may be determined as candidate values based on the capability of the IAB-DU or the instruction of the IAB-DU. In this case, the IAB-MT may select any one of one or more candidate values and report the selected candidate value to the IAB-DU.

Alternatively, according to the methods or options described above, the parent IAB-DU may instruct the IAB-MT that the DLPC power offset range (or the offset range of the desired downlink power control) configured or instructed is identical to the offset range of the provided downlink power control, or even without such instruction, the IAB-MT may assume or understand that the DLPC power offset range and the offset range of the provided downlink power control are identical to each other.

### Operation of the Parent IAB-DU According to the Request for the Desired Power Control

When the parent IAB-DU receives a request for desired power control having a value outside the DLPC power offset range according to the above-described methods, the method for handling this request may be based on at least one of the following options. For example, the value requested to decrease according to the desired downlink power control of the IAB-MT may be outside the minimum value of the DLPC power offset range, or the value requested to boost according to the desired downlink power control of the IAB-MT may be outside the maximum value of the DLPC power offset range. In such a case, the parent IAB-DU may operate based on the following options.

(1) Alt 1: When the power adjustment request (or a DLPC request) of the IAB-MT is outside the (expected) DLPC power offset range, the parent IAB-DU may determine occurrence of an invalid power adjustment request.

The request for power adjustment of the IAB-MT that is invalid for the parent IAB-DU may be handled as at least one of the following options.

Option 1: The parent IAB-DU may treat or determine that the power adjustment request of the IAB-MT does not occur in a situation that the power adjustment request of the IAB-MT is invalid. That is, the parent IAB-DU may not perform downlink power control in response to the power adjustment request of the IAB-MT.

Option 2: The parent IAB-DU may separately indicate that the power adjustment request of the IAB-MT is invalid.

Specifically, the parent IAB-DU may convey or transmit, to the IAB-MT via RRC/MAC-CE/DCI, instruction information indicating that the power adjustment request of the IAB-MT is invalid (e.g., an indicator of 1 bit, or an indicator of M bits to specify a specific time/frequency resource corresponding to the invalid request).

Alternatively, the parent IAB-DU may implicitly indicate that the power adjustment request of the IAB-MT is invalid. For example, the parent IAB-DU may implicitly indicate that the power adjustment request of the IAB-MT is invalid by providing the IAB-MT with information about the new DLPC power offset range (in response to the power adjustment request). For example, when the DLPC power offset range predicted or expected by the parent IAB-DU is [−Y dB to +Z dB] or the power adjustment value (or DLPC value) requested by the IAB-MT is +X dB (X>Z) (i.e., if the request is invalid), the parent IAB-DU may instruct the IAB-MT (via RRC/MAC-CE/DCI) with information of [−Y dB to +Z dB] based on at least one of Scenarios 1 to 3 described above. As described above, when the IAB-MT newly receives information on the DLPC power offset range in response to the power adjustment request, the IAB-MT may predict or determine that the power adjustment request (i.e., the power adjustment requested within a specific time before the information on the DLPC power offset range was instructed or the power adjustment requested most recently) is invalid and the power adjustment according to the request will not be performed.

Alternatively, the parent IAB-DU may explicitly indicate to the IAB-MT that the power adjustment request of the IAB-MT is invalid along with the information about the DLPC power offset range. For example, when the DLPC power offset range predicted or expected by the parent IAB-DU is [−Y dB to +Z dB] or the power adjustment value (or DLPC value) requested by the IAB-MT is +X dB (X>Z) (i.e., if the request is invalid), the parent IAB-DU may instruct the IAB-MT (via RRC/MAC-CE/DCI) about information of [−Y dB to +Z dB] along with the indication information indicating that the request is invalid, based on at least one of Scenarios 1 to 3 described above. In this way, when the information about the DLPC power offset range and the indication information indicating that the DLPC power offset range is invalid are transmitted together, the IAB-MT may predict or determine that the power adjustment request (i.e., the power adjustment requested within a specific time before the information on the DLPC power offset range was instructed or the power adjustment requested most recently) is invalid and the power adjustment according to the request will not be performed. Alternatively, when only the information about the DLPC power offset range is transmitted without transmission of the indication information indicating that the DLPC power offset range is invalid, the IAB-MT may determine that the requested power adjustment is valid and the DLPC power offset range for a subsequent power adjustment request is indicated.

(2) Alt. 2: When a power adjustment request of the IAB-MT located outside the predicted or expected DLPC power offset range is received, the parent IAB-DU may perform power adjustment with a value different from the value of the requested power adjustment.

For example, when the DLPC power offset range predicted or expected by the parent IAB-DU is −X (dB) to +Y (dB) and the IAB-MT requests power adjustment with a value less than −X (dB), the parent IAB-DU may consider or determine that the IAB-MT has requested power adjustment of −X (dB), which is a minimum value of the DLPC power offset range. In addition, when the DLPC power offset range predicted or expected by the parent IAB-DU is −X (dB) to +Y (dB) and the IAB-MT requests power adjustment with a value exceeding +Y (dB), the parent IAB-DU may consider or determine that the IAB-MT has requested power adjustment of +Y (dB), which is a maximum value of the DLPC power offset range.

### Power Control Offset Range for Providing Downlink Power Control

The parent IAB-DU may consider pre-configuring the power control offset range for which the provided downlink power control can be performed to the IAB-MT. For example, the parent IAB-DU may configure or instruct the IAB-MT to configure the power control offset range for which the provided downlink power control can be performed as the DLPC power offset range. The power control offset range for which the provided downlink power control can be performed may be the same as the offset range of the provided downlink power control described in Scenarios 1 to 3.

Alternatively, the offset range of the provided downlink power control may be different from the DLPC power offset range, and the parent IAB-DU may periodically/aperiodically indicate information about the DLPC power offset range to the IAB-MT via RRC/MAC-CE/DCI.

Alternatively, the parent IAB-DU may not separately configure the offset range of the provided downlink power control to the IAB-MT in advance for power control flexibility. For example, the offset range of the provided downlink power control of the parent IAB-DU is fixed according to the preset agreement or promise, and the IAB-MT may recognize, based on the fixed offset range, the offset value by which the DLPC is updated through the MAC-CE. For example, the offset range of the designable provided downlink power control may be agreed upon in advance as [−6, −3, 0, 3](dB), and the MAC-CE that transmits the provided DLPC may be composed of 2 bits, so that the MAC-CE can be mapped to each of the 2 bits and then instructed.

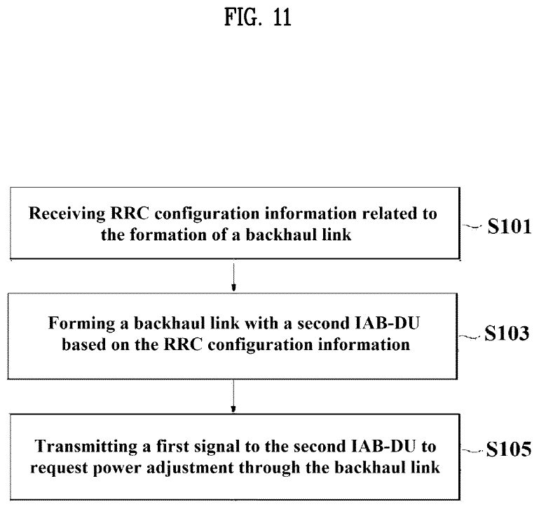

FIG. 11 is a flowchart illustrating a method for a first IAB to request adjustment of transmission (Tx) power for a backhaul link formed with a second IAB.

Hereinafter, the first IAB may be the child IAB described above, and the second IAB may correspond to the parent IAB described above.

Referring to FIG. 11, the first IAB (or the first IAB-MT) may receive RRC configuration information including configuration information related to the formation of the backhaul link (S101).

The first IAB may form a backhaul link with a DU of the second IAB based on the RRC configuration information (S103). Specifically, the MT (or the first IAB-MT) included in the first IAB may form the backhaul link with the DU (or the second IAB-DU) included in the second IAB, and may receive a downlink signal from the second IAB-DU or transmit an uplink signal to the second IAB-DU through the backhaul link.

The first IAB-MT may transmit a first signal for a power adjustment request to the second IAB-DU through the backhaul link (S105). Here, the first signal may be a signal including a first value related to the desired power adjustment request described above. The first value may correspond to a value of the desired transmission power of the second IAB-DU (e.g., the transmission power of the desired PDSCH), or may be an adjustment value of the desired transmission power of the second IAB-DU (e.g., an offset value which is a desired power increase value or a desired power decrease value). Meanwhile, the transmission power of the second IAB-DU adjusted according to the power adjustment request may be applied restrictively to a UE-specific signal.

Specifically, in the multiplexing case B described above, the first IAB-MT may transmit the first signal in order to ensure stability of AGC operation, prevention of quantization distortion, and amplifier linearity. Alternatively, in the multiplexing case D, the first IAB-MT may transmit the first signal in order to minimize signal interference caused by a difference between the transmission power of the DU (or, the first IAB-DU) included in the first IAB and the reception power of a signal (or, a downlink signal) transmitted by the second IAB-DU. That is, the first IAB-MT may reduce the difference between the reception power of the first IAB-MT and the reception power of the first IAB-DU (the multiplexing case B) by adjusting the reception power of the first IAB-MT in response to a request for adjustment of the transmission power of the second IAB-DU, or may reduce the difference between the reception power of the first IAB-MT and the transmission power of the first IAB-DU. For example, in the multiplexing case B or the multiplexing case D, the first IAB may transmit the first signal to the second IAB-DU if the difference between the reception power or transmission power of the first IAB-DU and the reception power of the first IAB-MT is greater than or equal to a preset threshold.

Alternatively, the first signal may include a first value for adjustment of the transmission power of the desired second IAB-DU. The first IAB may determine the first value within a predefined power adjustment range, a power adjustment range indicated by the second IAB, or a power adjustment range derived based on the RRC configuration information. Here, the power adjustment range may be a configuration corresponding to the DLPC power offset range described above. For example, the first IAB may receive instruction information or configuration information indicating the power adjustment range from the second IAB based on at least one of Scenarios 1 to 3 described above.

For example, based on Scenario 2 described above, the first IAB may predict or derive the transmission power of the CSI-RS based on the first power offset and/or the second power offset included in the RRC configuration information. Specifically, the first IAB may receive the RRC configuration information including information about the first power offset between the SSS and the CSI-RS or information about the second power offset between the PDSCH and the CSI-RS. Here, the first power offset may indicate a difference between the transmission power of the SSS (per RE) and the transmission power of the non-zero (NZP) CSI-RS (per RE), and the second power offset may indicate a difference between the transmission power of the PDSCH (per RE) and the transmission power of the NZP CSI-RS (per RE). For example, the first IAB may derive the transmission power of the CSI-RS by applying the second power offset to the transmission power of the PDSCH transmitted by the second IAB-DU. Alternatively, the first IAB may derive the transmission power of the CSI-RS by applying the first power offset to the transmission power of the SSS received from the second IAB-DU. In this case, the first IAB may determine the power adjustment range based on the derived or predicted transmission power of the CSI-RS. For example, the first IAB may determine the power adjustment range based on the difference between the derived or predicted transmission power of the CSI-RS and the maximum transmission power (and/or minimum transmission power) of the CSI-RS (included in the RRC configuration information). Alternatively, the first IAB may consider or expect that the power adjustment range is implicitly indicated or configured by the second IAB based on the difference between the derived or predicted transmission power of the CSI-RS and the maximum transmission power (and/or minimum transmission power) of the CSI-RS.

Alternatively, based on Scenario 1 described above, the first IAB may receive indication information related to the power adjustment range from the second IAB. For example, the first IAB may receive indication information related to the maximum value, minimum value, granularity of values, and/or number of included values related to the power adjustment range from the second IAB.

Alternatively, as described above, the first IAB may implicitly or explicitly configure or receive a configuration message or instruction of the power adjustment range from the second IAB. However, even if the first IAB implicitly or explicitly selects the first value from the power adjustment range and transmits the first signal including the first value, the second IAB may not adjust transmission power thereof according to the first signal. For example, when the first value is out of the power adjustment range related to the second IAB-DU, the second IAB-DU may treat the first signal as an invalid signal and may not adjust transmission power thereof according to the first signal.

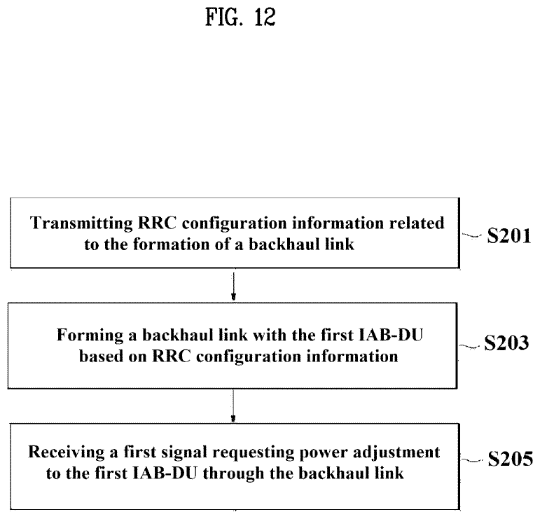

FIG. 12 is a flowchart illustrating a method for the second IAB to configure a power adjustment range for requesting adjustment of transmission (Tx) power for a backhaul link from the first IAB.

The second IAB (or the second IAB-DU) may transmit, to the first IAB (or the first IAB-MT), RRC configuration information including configuration information required to form the backhaul link (S201). Next, the second IAB may form the backhaul link with the first IAB based on the RRC configuration information (S203).

Alternatively, as in the above-described Scenarios 1 to 3, the second IAB may configure or instruct the first IAB about the power adjustment range related to the backhaul link. For example, the second JAB may explicitly configure or instruct the power adjustment range according to Scenario 1, and may implicitly configure or instruct the power adjustment range according to Scenario 2. Alternatively, information about the power adjustment range may be shared based on a table or the like that is agreed upon or defined in advance, as in Scenario 3. Specifically, the second JAB may explicitly configure or instruct the first JAB on the power adjustment range by transmitting information on a minimum value and/or a maximum value (and/or the granularity between values, the number of included values) related to the power adjustment range. Here, the value related to the power adjustment range may be determined either based on a power offset related to the transmission power of the CSI-RS included in the RRC configuration information as described above and/or based on a current transmission power of its own CSI-RS. Alternatively, the second JAB may preset a set of the plurality of power adjustment ranges according to Scenario 1, and may transmit, to the first IAB, indication information that indicates or configures any one of the plurality of power adjustment ranges included in the set. For example, the second JAB may transmit, to the first IAB, index information indicating a power adjustment range of any one of the plurality of power adjustment ranges. In addition, the second JAB may explicitly configure or instruct the first IAB on the power adjustment range through various configuration methods proposed in Scenario 1. Alternatively, as described with reference to FIG. 11, according to Scenario 2, the second JAB may expect or predict that the power adjustment range is implicitly configured based on the transmission power of the CSI-RS directly derived by the first JAB based on the first power offset or the second power offset included in the RRC configuration information.

Next, the second JAB may receive a first signal including a first value selected within the power adjustment range from the first IAB (S205). The second JAB may adjust the transmission power of a downlink signal thereof based on the first value. As described above, the second JAB may adjust the transmission power of the downlink signal using the first value, or may increase or decrease the transmission power of the downlink signal in response to the first value. Meanwhile, as described above, the second JAB may receive a first signal including a first value that is located outside the (explicitly/implicitly) configured power adjustment range. In this case, the second JAB may not perform power adjustment of the downlink signal according to the first signal since the first signal is an invalid power adjustment request. Alternatively, the second JAB may inform the first JAB that the first signal is for invalid power adjustment through a separate indicator. Alternatively, the second JAB may explicitly configure or instruct the power adjustment range to the first IAB, so that the second JAB may notify the first JAB that power adjustment according to the first signal is invalid and power adjustment is not performed accordingly.

In this way, the first JAB and the second JAB may predefine and/or explicitly/implicitly configure the power adjustment range related to the power change request, thereby inducing the first JAB to request power adjustment within a valid range or increasing the predictability of power adjustment. In addition, the second JAB may clearly determine the validity of the power adjustment request through the configuration of the power adjustment range. Alternatively, since the power adjustment range is implicitly or explicitly configured through various methods, the power adjustment range can be effectively indicated or configured appropriately according to the state of the signaling load. Furthermore, by determining the power adjustment range based on the value of the fixed CSI-RS included in the RRC configuration information, the first JAB and the second JAB may accurately predict the power adjustment range through the transmission power of the fixed CSI-RS even if the power adjustment range is implicitly indicated or configured.

Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

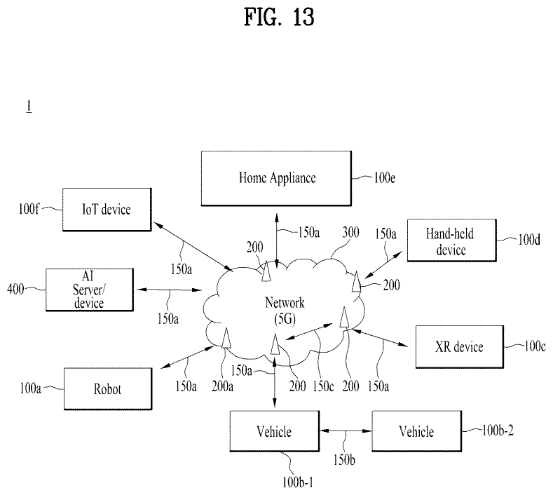

FIG. 13 illustrates a communication system applied to the present disclosure.

Referring to FIG. 13, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

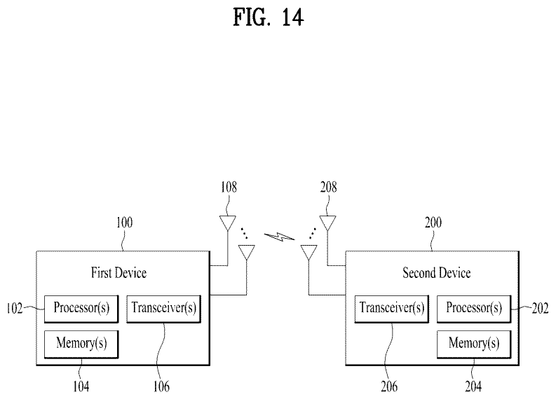

FIG. 14 illustrates a wireless device applicable to the present disclosure.

Referring to FIG. 14, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 13.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

According to one example, the first wireless device 100 or the first JAB may include a processor 102 and a memory 104 connected to the RF transceiver. The memory 104 may include at least one program capable of performing operations related to the embodiments described with reference to FIGS. 10 and 12.

Specifically, the processor 102 may control the RF transceiver 106 to receive RRC configuration information, may form a backhaul link with the DU of the second IAB based on the RRC configuration information, and may transmit, to the DU of the second JAB through the backhaul, the first signal that requests transmission power adjustment. Here, the first signal may include a first value selected within a power adjustment range determined based on the RRC configuration information.

Alternatively, the processor 102 and the memory 104 may be included in a chipset. In this case, the chipset may include at least one processor and at least one memory operatively connected to the at least one processor and configured to, when executed, cause the at least one processor to perform an operation. Here, the operation may include receiving RRC configuration information; forming a backhaul link with a distributed unit (DU) of the second JAB based on the RRC configuration information; and transmitting a first signal requesting adjustment of transmission power to the DU of the second JAB through the backhaul link. Additionally, the first signal may include a first value selected within a power adjustment range determined based on the RRC configuration information. Furthermore, the at least one processor may perform operations for the embodiments described in FIGS. 10 to 12 based on a program included in the memory.

Alternatively, a computer readable storage medium including at least one computer program for causing the at least one processor to perform an operation may be provided. Here, the operation may include receiving RRC configuration information; forming a backhaul link with a distributed unit (DU) of the second JAB based on the RRC configuration information; and transmitting a first signal requesting adjustment of transmission power to the DU of the second JAB through the backhaul link. The first signal may include a first value selected within a power adjustment range determined based on the RRC configuration information. Furthermore, the at least one processor may perform operations for the embodiments described in FIGS. 10 to 12 based on a program included in the memory. In addition, the computer program may include programs that can perform operations for the embodiments described with reference to FIGS. 10 to 12.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

According to one embodiment, the second JAB may include a processor 202, a memory 204, and/or a transceiver 206. The processor 202 may control the transceiver 206 or the RF transceiver to transmit RRC configuration information, may form a backhaul link with the MT included in the first IAB based on the RRC configuration information, and may receive a first signal requesting adjustment of transmission power for the backhaul link from the MT of the first IAB. The first signal may include a first value selected within a power adjustment range configured by the second IAB, and the power adjustment range may be determined based on the RRC configuration information.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Application of Wireless Devices to which the Present Invention is Applied

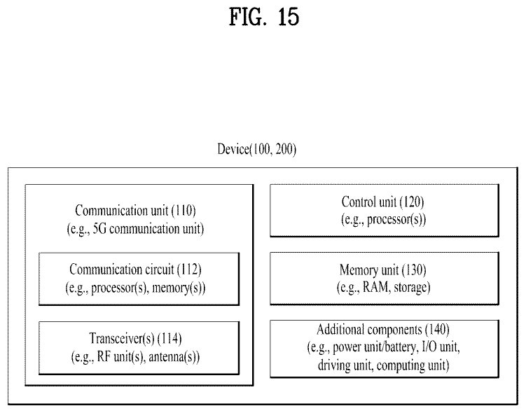

FIG. 15 illustrates another example of a wireless device applied to the present disclosure.

Referring to FIG. 15, wireless devices 100 and 200 may correspond to the wireless devices 100 and 200 of FIG. 14 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 14. For example, the transceiver(s) 114 may include the one or more transceivers 106 and 206 and/or the one or more antennas 108 and 208 of FIG. 14. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 13), the vehicles (100b-1 and 100b-2 of FIG. 13), the XR device (100c of FIG. 13), the hand-held device (100d of FIG. 13), the home appliance (100e of FIG. 13), the IoT device (100f of FIG. 13), a digital broadcast terminal, a hologram device, a public safety device, an MTC device, a medicine device, a fintech device (or a finance device), a security device, a climate/environment device, the AI server/device (400 of FIG. 13), the BSs (200 of FIG. 13), a network node, etc. The wireless device may be used in a mobile or fixed place according to a use-example/service.

In FIG. 15, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure.

### INDUSTRIAL APPLICABILITY

The above-described embodiments of the present disclosure are applicable to various mobile communication systems.

1. A method comprising:
receiving, by a first IAB (Integrated Access and Backhaul), radio resource control (RRC) configuration information;
forming, by the first IAB, a backhaul link with a distributed unit (DU) of a second IAB based on the RRC configuration information; and
transmitting, by the first IAB, a first signal requesting adjustment of transmission power to the DU of the second IAB through the backhaul link,
wherein the first signal includes a first value selected within a power adjustment range determined based on the RRC configuration information.

2. The method according to claim 1, wherein the power adjustment range is determined based on information on a power offset related to a CSI-RS (channel state information reference signal) included in the RRC configuration information.

3. The method according to claim 2, wherein the RRC configuration information includes information about a first power offset between a secondary synchronization signal (SSS) and a CSI-RS, or information about a second power offset between a PDSCH and a CSI-RS.

4. The method according to claim 3, wherein the power adjustment range is determined based on the first power offset or the second power offset.

5. The method according to claim 3, wherein the first IAB is configured to:
calculate transmission power of the CSI-RS by applying the first power offset to transmission power related to the SSS; and
determine the power adjustment range based on the calculated transmission power of the CSI-RS.

6. The method according to claim 3, wherein the first IAB is configured to:
calculate transmission power of the CSI-RS by applying the second power offset to transmission power related to the PDSCH; and
determine the power adjustment range based on the calculated transmission power of the CSI-RS.

7. The method according to claim 1, wherein the power adjustment range is determined based on instruction information received from the DU included in the second IAB and the RRC configuration information.

8. The method according to claim 7, wherein the instruction information includes at least one of a minimum value and a maximum value of the power adjustment range.

9. The method according to claim 1, wherein the first value is a power offset value for increasing or decreasing transmission power of the DU included in the second IAB.

10. A first IAB (Integrated Access and Backhaul) comprising:
a radio frequency (RF) transceiver; and
a processor connected to the RF transceiver,
wherein the processor is configured to:
receive radio resource control (RRC) configuration information under control of the RF transceiver;
form a backhaul link with a distributed unit (DU) of a second IAB based on the RRC configuration information; and
transmit a first signal requesting adjustment of transmission power to the DU of the second IAB through the backhaul link,
wherein the first signal includes a first value selected within a power adjustment range determined based on the RRC configuration information.

11. A method comprising:
transmitting, by a second IAB (Integrated Access and Backhaul), radio resource control (RRC) configuration information;
forming, by the second IAB, a backhaul link with a mobile termination (MT) included in the first IAB based on the RRC configuration information; and
receiving, by the second IAB, a first signal requesting adjustment of transmission power for the backhaul link from the MT of the first IAB,
wherein the first signal includes a first value selected within a power adjustment range configured by the second IAB, and the power adjustment range is determined based on the RRC configuration information.

12. The method according to claim 11, wherein the second IAB is configured to:
configure the power adjustment range by instructing the first IAB about at least one of a minimum value and a maximum value of the power adjustment range.

13. The method according to claim 12, wherein the second IAB is configured to:
configure the power adjustment range by instructing the first IAB about transmission power of a CSI-RS (channel state information reference signal).

14-15. (canceled)
